(19) United States
(12) Patent Application Publication
(10) Pub. No.: US 2012/0263391 A1
(43) Pub. Date: Oct. 18, 2012

(54) IMAGE DISPLAY APPARATUS AND METHOD FOR REVERSELY DISPLAYING IMAGES THEREOF

(75) Inventors: Jun-Shik JEON, Yongin-si (KR); Taehyun KIM, Seongnam-si (KR); Minsu JEON, Seoul (KR)

(73) Assignee: SAMSUNG ELECTRONICS CO., LTD., Suwon-si (KR)

(21) Appl. No.: 13/447,885

(22) Filed: Apr. 16, 2012

(30) Foreign Application Priority Data
Apr. 15, 2011 (KR) 10-2011-0034976

(51) Int. Cl. G06K 9/36

(52) U.S. Cl. 382/233

(57) ABSTRACT

Provided are an image display apparatus and a method for reversely displaying images of the image display apparatus. The image display apparatus includes a stream scheduler configured to schedule image frames in a received image stream, a memory including a reverse display storage region allocated for reverse display, a decoder configured to decode the scheduled image frames and store the decoded image frames in the reverse display storage region of the memory, and a display unit configured to reversely display the image frames in the reverse display storage region through the decoder. The decoder stores subsequent decoded image frames following the decoded image frames in storage regions of reverse-display-terminated image frames in the reverse display store region if the decoded image frames are all stored in the reverse display storage region.

### CROSS-REFERENCE TO RELATED APPLICATION

This application claims priority under 35 USC §119 from Korean Patent Application No. 10-2011-0034976, filed on Apr. 15, 2011, the disclosure of which is hereby incorporated by reference in its entirety.

### BACKGROUND

Exemplary embodiments described herein generally relates to image display apparatuses and, more particularly, an image display apparatus capable of performing single-speed (1×) reverse display and a method for reversely displaying images of the image display apparatus.

When reversely displaying an encoded image stream, an image display apparatus displays only an I-frame to provide double-speed (2×) display or quad-speed (4×) display. The encoded image stream includes an intra-frame (I-frame), a predicted frame (P-frame), and a bidirectional frame (B-frame). Among these frames, the I-frame contains independent image information and may be compressed and restored irrespective of the other frames.

Accordingly, a user of an image display apparatus may check only broken images because the P-frame and the B-frame are not displayed during a reverse display operation.

However, all image frames must be decoded for single-speed (1×) reverse display. To achieve this, an image display apparatus must store image frames decoded for reverse display in a memory. Accordingly, unlike 2× or 4× reverse display, 1× reverse display requires increased memory size to store an image framed decoded as all image frames are decoded. Moreover, since the decoded image frame increases in size as an image increases in size, there is a need to minimize a size of a memory for use in an image display apparatus.

### SUMMARY OF THE INVENTION

Exemplary embodiments provide an image display apparatus and a method for reversely displaying images of the image display apparatus.

According to an exemplary embodiment, there is provided an image display apparatus including a stream scheduler configured to schedule image frames in an image stream; a memory including a reverse display storage region allocated for reverse display; a decoder configured to decode the scheduled image frames and store the decoded image frames in the reverse display storage region; and a display unit configured to reversely display the decoded image frames stored in the reverse display storage region by the decoder. The decoder may store subsequent decoded image frames following the decoded image frames in storage regions of reverse-display-terminated image frames in the reverse display store region if the decoded image frames are all stored in the reverse display storage region.

In this embodiment, if the decoded image frames are all stored in the reverse display storage region, the display unit reversely may display the image frames stored in the reverse display storage region in a predetermined reverse display order.

In this embodiment, if a group of pictures (GOP) comprising the image frames stored in the reverse display storage region is a last GOP, the display unit may reversely display the image frames stored in the reverse display storage region in a predetermined reverse display order.

In this embodiment, the reverse display storage region may have a size smaller than that of a region needed to store one GOP and one image frame therein.

In this embodiment, if a reference image frame of non-reference image frames in the image stream is included in a GOP including the non-reference image frames, the stream scheduler may schedule image frames to be decoded in a unit of one GOP.

In this embodiment, if a reference image frame of non-reference image frames in the image stream is included in a GOP that is different from a GOP including the non-reference image frames, the stream scheduler may schedule the other image frames except image frames referring to the different GOP to be decoded and schedules the reference image frame of the different GOP to be decoded ahead of the image frames referring to the different GOP.

According to another exemplary embodiment, there is provided a method for reversely displaying images of an image display apparatus, the method including scheduling image frames of an image stream; decoding the scheduled image frames; storing the decoded image frames in a reverse display storage region in a memory; and reversely displaying the image frames stored in the reverse display storage region. The storing of the decoded image frames may include, if the decoded image frames are all stored in the reverse display storage region, storing subsequent decoded image frames following the decoded image frames in storage regions of reverse-display-terminated image frames in the reverse display storage regions.

In this embodiment, the reversely displaying of the decoded image frames may include, if the decoded image frames are all stored in the reverse display storage region, reversely displaying the image frames stored in the reverse display storage region in a predetermined reverse display order.

In this embodiment, the reversely displaying of the decoded image frames may include, if a GOP comprising image frames stored in the reverse display storage region is a last GOP for reverse display, reversely displaying the image frames stored in the reverse display storage region in a predetermined reverse display order.

In this embodiment, the reverse display storage region may have a size smaller than that of a region needed to store one GOP and one image frame therein.

In this embodiment, the scheduling of the image frames of the image streams may include, if a reference image frame of non-reference image frames in the image stream is included in a GOP including the non-reference image frames, scheduling the image frames to be decoded in the unit of one GOP.

In this embodiment, the scheduling of the image frames of the image streams may include, if a reference image frame of non-reference image frames in the image stream is included in a GOP including the non-reference image frames, scheduling the other image frames to be decoded except image frames referring to a GOP that is different from the GOP including the non-reference image frames; scheduling a reference image frame of the different GOP to be decoded; and scheduling image frames referring to the different GOP to be decoded.

### BRIEF DESCRIPTION OF THE DRAWINGS

Exemplary embodiments will become more apparent in view of the accompanying detailed description and attached drawings, in which:

FIG. 1 illustrates an image display apparatus according to an exemplary embodiment;

FIG. 2 is a flowchart illustrating an image reserve display operation of an image display apparatus according to an exemplary embodiment;

FIG. 3 is a flowchart illustrating an image scheduling process of an image display apparatus according to an exemplary embodiment;

FIG. 4 is a flowchart illustrating an image scheduling operation when a reference image is included in one image area, according to an exemplary embodiment;

FIG. 5 illustrates an image scheduling operation when a reference image is included in one image area, according to an exemplary embodiment;

FIG. 6 is a flowchart illustrating an image scheduling operation when a reference image is not included in one image area, according to an exemplary embodiment;

FIG. 7 illustrates an image scheduling order according to an exemplary embodiment;

FIG. 8 illustrates an image scheduling operation when a reference image is not included in one image area, according to an exemplary embodiment;

FIG. 9 illustrates an image scheduling operation when a reference image is not included in one image area, according to another exemplary embodiment; and

FIG. 10 illustrates image storage and display operations when a reference image is not included in one image area, according to another exemplary embodiment.

### DETAILED DESCRIPTION

The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose examples of the inventive concept and to let those skilled in the art understand the nature of the inventive concept.

In the drawings, like reference numerals refer to the same or similar elements. The drawings are not necessarily to scale, emphasis instead being placed upon illustrating aspects of the inventive concept.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the tell is first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. In the drawings, like reference numerals in the drawings denote like elements. The shape, size and regions, and the like, of the drawing may be exaggerated for clarity.

Exemplary embodiments are directed to an image display apparatus providing single-speed (1×) reverse display. The image display apparatus may use a storage area used for reverse display in a memory after predetermining a size of the storage area. Herein, the term “reverse display” means an operation of displaying images in a reverse direction.

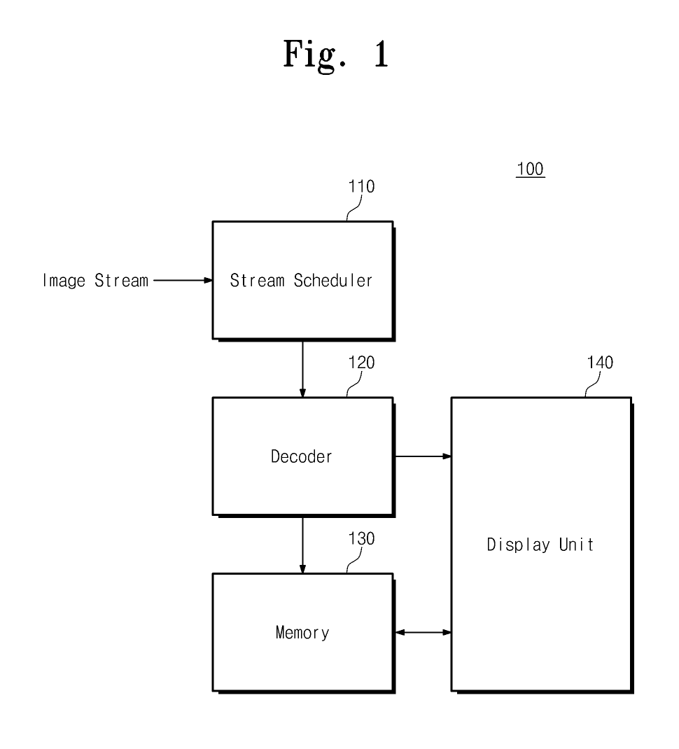

FIG. 1 illustrates an image display apparatus 100 according to an exemplary embodiment. As illustrated, the image display apparatus 100 includes a stream scheduler 110, a decoder 120, a memory 130, and a display unit 140.

The stream scheduler 110 receives an image stream and schedules image frames included in the received image stream. That is, the stream scheduler 110 schedules a decoding order of image frames for reverse display of an image.

For example, the image stream includes encoded image frames of intra-frame (I-frame), a predicted frame (P-frame), and a bidirectional frame (B-frame). Among these frames, the I-frame contains independent image information and may be compressed and restored irrespective of the other frames. The P-frame is a frame in which only a different portion is calculated by comparison with a previous frame to encode only a different value. The B-frame is a frame for interpolation and has a different value between I-frames (or P-frames) previous to or subsequent to a B-frame.

A group of successive frames (e.g., P-frames or B-frames) may be defined as a group of pictures (GOP), on the basis of one I-frame.

The stream scheduler 110 may schedule image frames according to two cases: a closed GOP (in which a reference image (I-frame or P-frame) for image decoding to a GOP in an image stream exists in one GOP) and an open GOP (in which a reference image (I-frame or P-frame) for image decoding to a GOP in an image stream does not exist in one GOP), respectively.

A scheduling operation of the stream scheduler 110 will be described in detail later with reference to accompanying drawings. The stream scheduler 110 outputs scheduled image frames to the decoder 120.

The decoder 120 sequentially decodes the scheduled image frames. The decoder 120 stores the scheduled image frames in the memory 130. The decoder 120 stores a decoded image frame in a reverse display storage region in the memory 130. In addition, the decoder 120 decodes all image frames for 1× reverse display (e.g., I-frames, P-frames, and B-frames). In this case, a size of the reverse display storage region is equivalent to sizes of a region to store a GOP and a region to store one image frame. The reverse display storage region may be referred to as, for example, a decoded picture buffer (DPB).

The decoder 120 sequentially stores the image frames decoded in the reverse display storage region. In this case, when the storage of the decoded image frames is completed, the decoder 120 stores a decoded image frame at a position where an image frame displayed in the reverse display storage region is stored. The decoder 120 provides display order information and storage position information on respective image frames for display to the display unit 140.

The memory 120 may store decoded data for reverse display in the reverse display storage region.

The display unit 140 may reversely display image frames by using the display order information and the storage position information received from the decoder 120. At this point, the display unit 140 may reversely display an image at a single speed (1×) because it is decoded with respect to the I-frame, the P-frame, and the B-frame.

A memory space having a size to store at least two GOPs may be required for reverse display. A storage region to store one GOP is used for reverse display, and a storage region to store another GOP is used to store decoded image frames.

However, in the exemplary embodiment, the decoder 120 uses a predetermined reverse display storage region to reversely display an image in the memory 130. The reverse display storage region is set not to exceed a size including all image frames in one GOP and one image frame. For example, if one GOP includes ten image frames, a reverse display storage region may eleven (10+1) image frames or less.

Among image frames, a P-frame or a B-frame refers to information of another image. Thus, the reverse display storage region is set to a size to all reference image frames (e.g., I-frame or P-frame) capable of reversely displaying image frames such as the P-frame or the B-frame.

As a result, the image display apparatus 100 according to the exemplary embodiment may minimally use a region of the memory 130 used for reverse display.

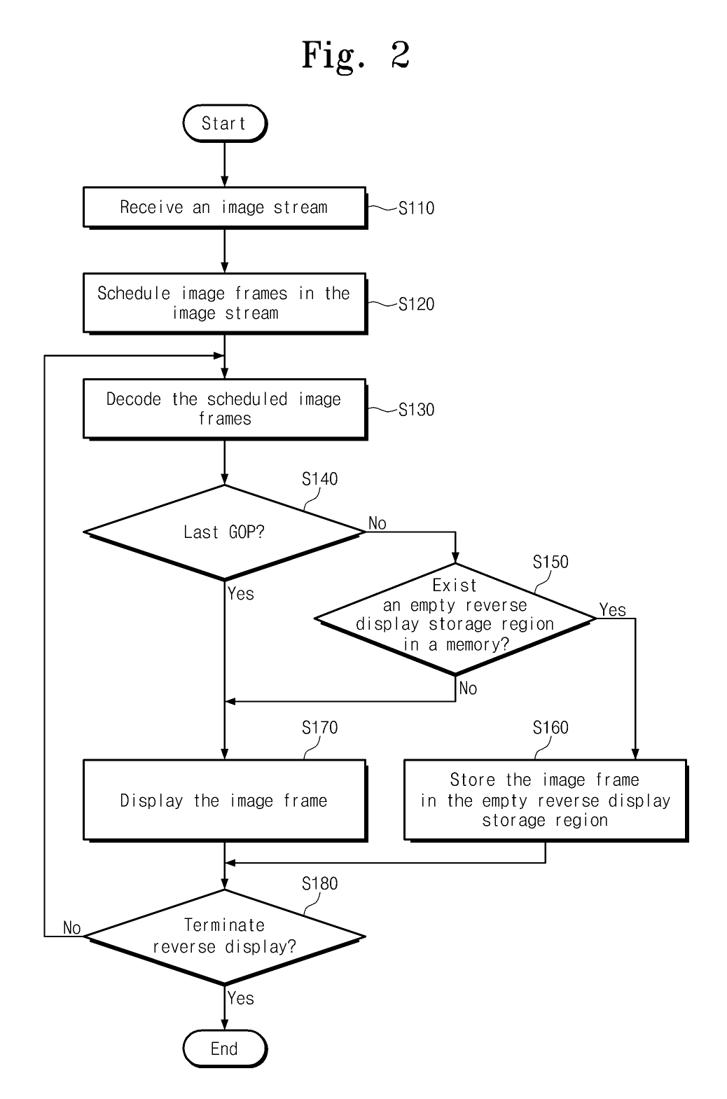

FIG. 2 is a flowchart illustrating an image reserve display operation of an image display apparatus according to an exemplary embodiment.

Referring to FIG. 2, a stream scheduler 110 receives an image stream (S110).

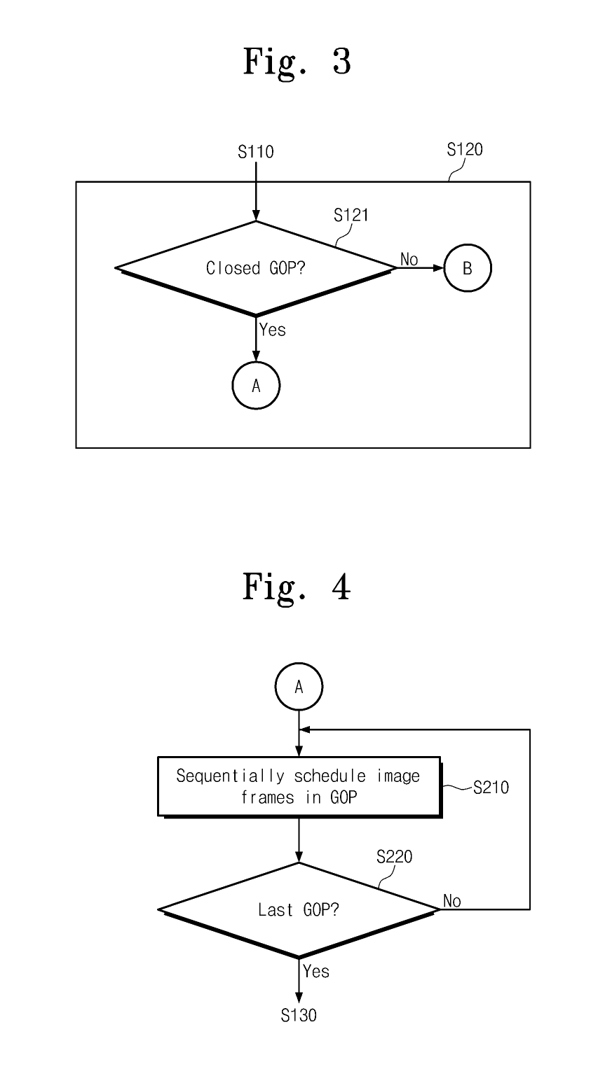

The stream scheduler 110 schedules image frames in the image stream (S120). The image frames may include a plurality of GOPs. A GOP may include an I-frame, a P-frame, and a B-frame. As an example, the stream scheduler 110 schedules image frames with respect to a GOP according to two cases: a closed GOP and an open GOP. The scheduling operation of the stream scheduler 110 will be described in detail later with reference to FIGS. 3, 4, and 6.

The decoder 120 sequentially decodes the scheduled image frames (S130).

The decoder 120 determines whether the decoded image is the last GOP for reverse display (S140). As an example, reverse display of images may be selected in the unit of GOP.

As a result of the determination in 5140, if the current image is the last GOP, the decoder 120 proceeds to S170. On the other hand, if the current image is not the last GOP, the decoder 120 proceeds to S150.

The decoder 120 checks whether an empty reverse display storage region to store the decoded image exists in a memory (S150). As a result of the checking in S150, if the empty reverse display storage region does not exist, the decoder 120 proceeds to S170. On the other hand, if the empty reverse display storage region exits, the decoder 120 proceeds to S160.

The decoder 120 stores the image frames sequentially stored in the empty reverse display storage region (S160). When storing the decoded image frame in the reverse display storage region, the decoder 120 proceeds to S180.

The display unit 140 reversely displays the decode image frame (S170). Additionally, the decoded image frame may exist in the decoder 120. In this case, the decoder 120 stores the decoded image frame in a reverse display storage region of a reverse-display-terminated image frame in the memory 130.

The display unit 140 checks whether the reverse display is terminated (S180). If it is determined that the reverse display is not terminated as a result of the checking in S180, the display unit 140 proceeds to S130. On the other hand, if it determined that the reverse display is terminated, the reverse display operation of an image is completed.

The image display apparatus 100 according to the exemplary embodiment uses a reverse display storage region having a predetermined size in the memory 130 to reversely display images. The image display apparatus 100 sequentially stores decoded images frames in the reverse display storage region. After storing all the image frames in the reverse display storage region, the image display apparatus 100 stores the decoded image frames in a reverse display storage regions of display-terminated image frames.

As a result, the image display apparatus 100 uses a reverse display storage region having a minimized size in the memory 130 for reverse display of images to thus minimize the use of a storage region in the memory 130 for reverse display of images.

FIG. 3 is a flowchart illustrating an image scheduling process of an image display apparatus according to an exemplary embodiment.

Referring to FIG. 3, a scheduling operation (S120 in FIG. 2) of a stream scheduler 110 is illustrated. The stream scheduler 110 determines whether an encoding manner of image frames in an image stream is a closed GOP (S121).

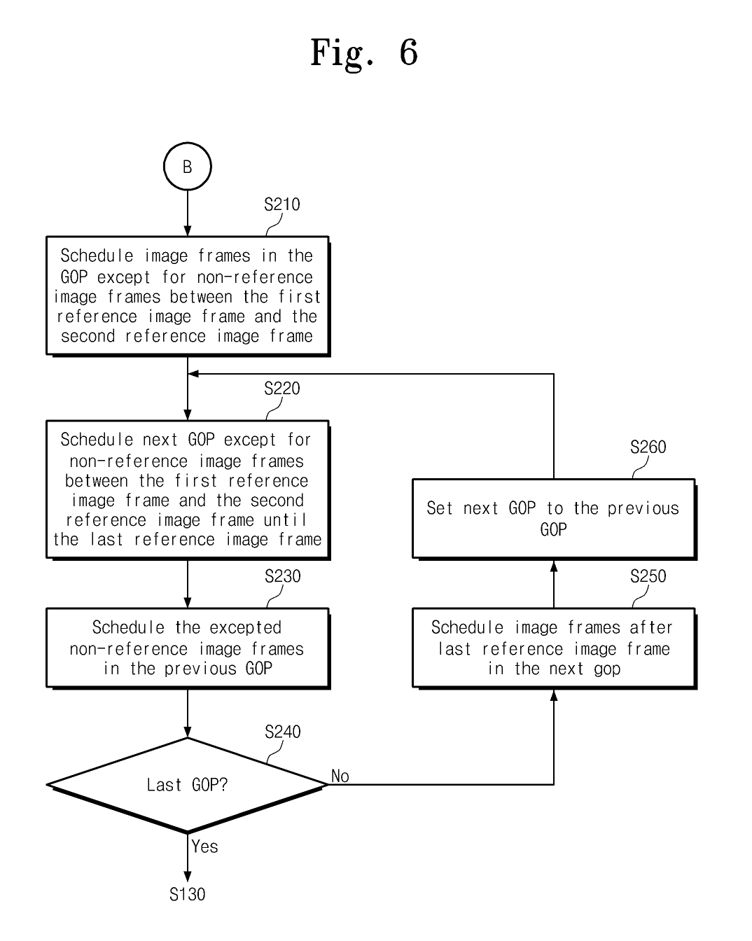

If is determined that a GOP includes the closed GOP in S121, the stream scheduler 110 proceeds to S210 (A) in FIG. 4. On the other hand, if it is determined that a GOP is not the closed GOP, i.e., is an open GOP, the stream scheduler 110 proceeds to S310 (B) in FIG. 6.

A closed GOP is a GOP that includes all reference image frames in one GOP. An open GOP is a GOP that does not include all reference image frames in one GOP and uses a reference image frame included in another GOP.

Accordingly, the stream scheduler 110 performs different scheduling operations between a closed GOP and an open GOP to reversely display images.

FIG. 4 is a flowchart illustrating an image scheduling operation when a reference image according to an exemplary embodiment is included in one image area.

Referring to FIG. 4, a stream scheduler 110 sequentially schedules all image frames in a GOP (S210). At this point, the stream scheduler 110 schedules from a first GOP for reverse display. If the stream scheduler 110 schedules all the image frames in the GOP, the stream scheduler 110 proceeds to S220.

The stream scheduler 110 checks whether the scheduled GOP is the last GOP (S220). If it is determined that a current GOP is not the last GOP, the stream scheduler 110 proceeds to S210. If it determined that the current GOP is the last GOP, the stream scheduler 110 stops the scheduling operation and proceeds to S130.

As described in FIG. 4, the stream scheduler 110 may schedule a closed GOP to sequentially decode GOPs in a reverse display order and schedule image frames in a GOP to sequentially decode from an I-frame. However, the stream scheduler 110 may decode the image frames in the GOP in a different order.

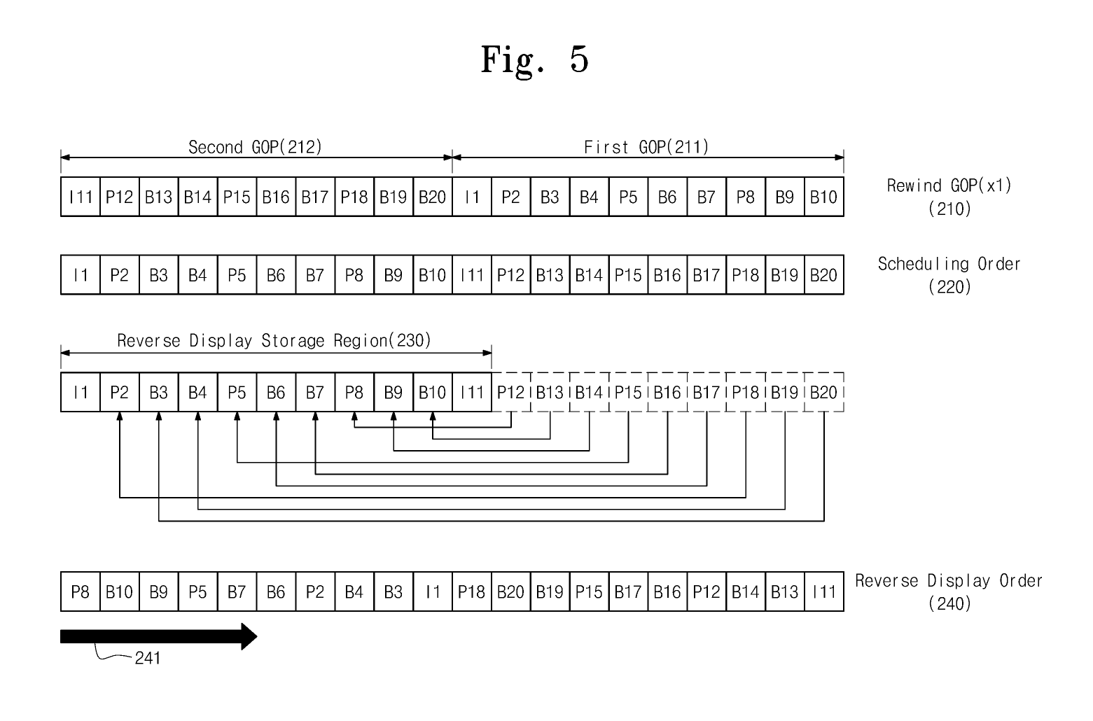

FIG. 5 illustrates an image scheduling operation when a reference image is included in one image area, according to an exemplary embodiment.

Referring to FIG. 5, a reverse GOPs 210 are GOPs for 1× reverse display and include a first GOP 211 and a second GOP 212.

The first GOP 211 is reversely displayed ahead of the second GOP 212. Each of the first and second GOPs 211 and 212 includes ten image frames.

The first GOP 211 includes image frames I1, P2, B3, B4, P5, B6, B7, P8, B9, and B10, wherein the letters I, P and B represent kinds of image frames (I-frame, P-frame, and B-frame) and the numerals represent indexes of the image frames. The second GOP 212 includes image frames I11, P12, B13, B14, P15, B16, B17, P18, B19, and B20.

The stream scheduler 110 receives an image stream including the first GOP 211 and the second GOP 212. The stream scheduler 110 sequentially schedules from the image frame I1 to the image frame B10 of the first GOP 211. Next, the stream scheduler 110 sequentially schedules from the image frame I11 to the image frame B20 of the second GOP 212. The scheduling order 220 of the image frames scheduled by the stream scheduler 110 is as follows: I1→P2→B3→B4→P5→B6→B7→P8→B9→B10→I11→P12→B13→B14→P15→B16→B17→P18→B19→B20.

The decoder 120 decodes image frames in the order scheduled by the stream scheduler 110. The image frames decoded by the decoder 120 are stored in a reverse display storage region 230 in the memory 130. The reverse display storage region 230 is shown by a solid line. The reverse display storage region 230 has a size to store one GOP (ten image frames) and one image frame. Thus, the reverse display storage region 230 may store maximum eleven image frames.

The decoder 120 sequentially stores the image frames I1, P2, B3, B4, P5, B6, B7, P8 B9, B10, and I11 in the reverse display storage region 230 in the memory 130. In addition, the decoder 120 sequentially stores the image frames P12, B13, B14, P15, B16, B17, P18, B19, and B20 in storage regions of display-terminated image frames in the reverse display storage region.

For example, a display unit 140 may display the image frame P8 that is a first reverse display image frame when the image frame I11 is stored in the memory 130. Thus, the decoder 120 stores the image frame P12 in a storage region of the display-terminated image frame P8. According to the reverse display order 240 of the image frames, the decoder 120 stores the image frames B13, B14, P15, B16, B17, P18, B19, and B20 in storage regions of the image frames B10, B9, B5, B7, B6, P2, P4, and B3, respectively.

Image frames are reversely displayed in the reverse display order 240. The reverse display order 240 of the image frames is as follows: P8→B10→B9→P5→B7→B6→P2→B4→B3→I1→P18→B20→B19→P15→B17→B16→P12→B14→B13→I11. The display unit 140 reversely displays image frames in the reverse display order 240. A reverse display direction based on the reverse display order 240 is indicated by an arrow 241. The display unit 140 may confirm storage region information of respective image frames through the decoder 120 and access the memory 110 to display an image frames in the reverse display order.

FIG. 6 is a flowchart illustrating an image scheduling operation when a reference image is not included in one image area, according to an exemplary embodiment.

Referring to FIG. 6, a stream scheduler 110 sequentially schedules image frames in a GOP (e.g., first GOP) except non-reference image frames (e.g., B-frames) between a first reference image frame (e.g., I-frame) and a second reference image frame (e.g., P-frame) (2). The non-reference image frames are images frames using a reference image in another GOP for display.

The stream scheduler 110 sequentially schedules image frames to the last reference image frame (e.g., P-frame) except non-reference image frames (e.g., B-frames) between a first reference image frame (e.g., I-frame) and a second reference image frame (e.g., P-frame) in the next GOP (e.g., second GOP) (S220).

The stream scheduler 110 schedules unscheduled non-reference images frames in a previous GOP (e.g., first GOP) (S230).

The stream scheduler 110 confirms whether a scheduling-terminated image frame is the last image frame (S240). As a result of the confirmation in S240, if the scheduling-terminated image frame is the last image frame, the stream scheduler 110 proceeds to S130. On the other hand, if the scheduling-terminated image frame is not the last image frame, the stream scheduler 110 proceeds to S250.

The stream scheduler 110 schedules image frames (e.g., non-reference image frame (B-frames)) following the last reference image frame in the next GOP (e.g., second GOP) (S250). That is, the stream scheduler 110 schedules the other image frames except the image frames not scheduled in S220.

The stream scheduler 110 sets the next GOP (e.g., second GOP) as a previous GOP (e.g., first GOP) (S260). The stream scheduler 110 sets the next GOP (e.g., second GOP) as a previous GOP (e.g., first GOP) and proceeds to S220.

As described in FIG. 6, with respect to an open GOP, when the stream scheduler 110 sequentially decodes GOPs in a reverse displayer order, it schedules image frames using a reference image frame in another GOP to be decoded following the reference image frame therein.

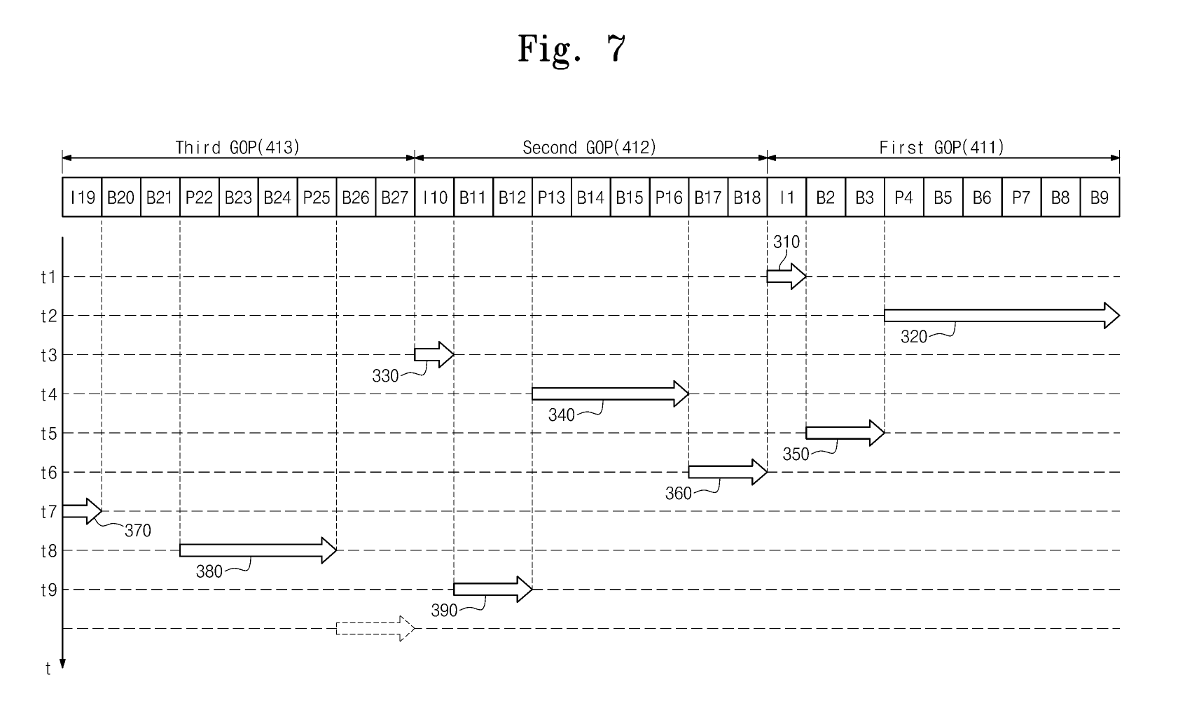

FIG. 7 illustrates an image scheduling order according to an exemplary embodiment.

Referring to FIG. 7, a first GOP 411, a second GOP 412, and a third GOP 413 each include, for example, nine image frames.

The first GOP 411 includes image frames I1, B2, B3, P4, B5, B6, P7, B8, and B9′, wherein the letter I, B and P represent kinds of image frames (I-frame, P-frame, and B-frame) and numerals represent indexes of the image frames. The second GOP 412 includes image frames I10, B11, B12, P13, B14, B15, P16, B17, and B18. The third GOP 413 includes image frames I19, B20, B21, P22, B23, B24, P25, B26, and B27.

It is assumed that reverse display GOPs are the first GOP 411 and the second GOP 412. The first GOP 411 is reversely displayed ahead of the second GOP 412.

A scheduling order of image frames according to time (t) is shown by arrows.

At a first time point t1, a stream scheduler 110 performs a scheduling operation (310) for the image frame I1 included in the first GOP 411.

At a second time point t2, the stream scheduler 110 performs a scheduling operation (320) for image frames P4, B5, B6, P7, B8, and B9 included in the first GOP except image frames B2 and B3 referring to another GOP, e.g., the second GOP 412.

At a third time point t3, the stream scheduler 110 performs a scheduling operation (330) for an image frame 110 included in the next GOP, i.e., the second GOP 412.

At a fourth time point t4, the stream scheduler 110 performs a scheduling operation (340) for image frames P13, B14, B15, and P16 to the last reference image frame (i.e., P16) in the second GOP 412 except image frames B11 and B12 referring to further another image frame, e.g., a third GOP 413.

At a fifth time point, the stream scheduler 110 performs a scheduling operation (350) for the image frames B2 and B3 that are included in the first GOP 411 and unscheduled at the second time point t2.

At a sixth time point t6, the stream scheduler 110 performs a scheduling operation (360) for the image frame B17 and B18 that are included in the second GOP 412 and unscheduled at the fourth time point t4.

At a seventh time point t7, the stream scheduler 110 performs a scheduling operation (370) for an image frame 119 included in the next GOP, i.e., the third GOP 413.

At an eighth time point t8, the stream scheduler 110 performs a scheduling operation 380 for image frames P22, P23, B24, and P25 to the last reference image frame (i.e., P25) in the third GOP 413 except image frames B20 and B21 referring to an image following another GOP, e.g., the third GOP 413.

At a ninth time point t9, the stream scheduler 110 performs a scheduling operation (390) for image frames B17 and B18 that are included in the second GOP 412 and unscheduled at the eighth time point t8.

The stream scheduler 110 sequentially performs scheduling operations according to the flow from the first time point t1 to the ninth time point t9

Through the above scheduling operations, an image display apparatus 100 may reversely display image frames of an open GOP at a single-speed (1×) while minimizing use of a memory 110 for reverse display of images.

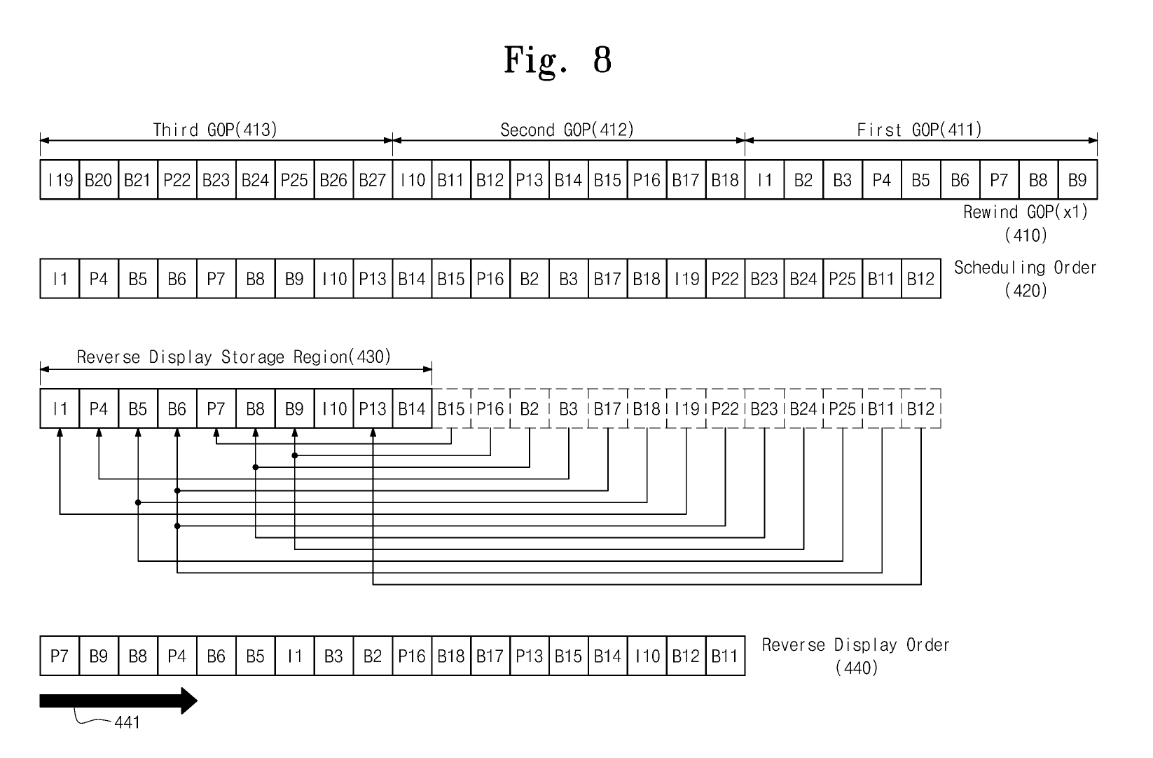

FIG. 8 illustrates an image scheduling operation when a reference image is not included in one image area, according to an exemplary embodiment.

Referring to FIG. 8, reverse display GOPs 410 are GOPs for 1× reverse display and include a first GOP 411, a second GOP 412, and a third GOP 413.

The first GOP 411 is reversely displayed ahead of the second GOP 412. It is assumed that practically displayed GOPs are the first GOP 411 and the second GOP 412. In addition, a scheduling operation to schedule the first GOP 411 and the second GOP 412 will refer to FIG. 7.

The first GOP 411, the second GOP 412, and the third GOP 413 each include nine image frames.

The first GOP 411 includes image frames I1, B2, B3, P4, B5, B6, P7, P8, and B9. The second GOP 412 includes image frames I10, B11, B12, P13, B14, B15, P16 B17, and B18. The third GOP 413 includes image frames 119, B20, B21, P22, B23, B24, P25, B26, and B27.

A stream scheduler 110 receives an image stream including the first GOP 411, the second GOP 412, and the third GOP 413. The stream scheduler 110 schedules images frames in the order described in FIG. 7. A scheduling order 420 of the image frames scheduled by the stream scheduler 110 is as follows: I1→P4→B5→B6→P7→B8→B9→I10→P13→B14→B15→P16→B2→B3→B17→B18→I19→P22→B23→B24→P25→B11→B12.

A decoder 120 decodes the image frames in the same order as scheduled by the stream scheduler 110. The image frames decoded by the decoder 120 are stored in a reverse display storage region 430 in a memory 130. The reverse display storage region 430 is shown by a solid line. The reverse display storage region 430 has capacity to store one GOP (nine image frames) and one image frame. Therefore, the reverse display storage region 430 may store maximum ten image frames.

The decoder 120 sequentially stores the image frames I1, P4, B5, B6, P7, B8, B9, I10, P13, and B14 in the reverse display storage region 430 of the memory 130. The decoder 120 sequentially stores the image frames B15, P16, B2, B3, B17, B18, 119, P22, B23, B24, P25, B11, and B12 in storage regions of display-terminated image frames in the reverse display storage region 430.

For example, a display unit 140 may display the image frame P7 that is a first reverse display image frame when the image frame B14 is stored in the memory 130. Therefore, the decoder 120 stores the image frame B15 in a storage region of the display-terminated image frame P7. In an image frame reverse display order 240, the decoder 120 stores the image frames P16, B2, B3, B17, B18, 119, P22, B23, B24, P25, B11, and B12 in storage regions of the image frames B9, B8, P4, B6, B5, I1, B3(B6), B2(B8), P16(B9), B18(B5), B11(B6), and P13, respectively.

Image frames are reversely displayed in a reverse display order 440. At this point, the reverse display order 440 of the image frames is as follows: P7→B9→B8→P4→B6→B5→I1→B3→B2→P16→B18→B17→P13→B15→B14→I10→B12→B11. The display unit 140 may confirm storage region information of each image frame through the decoder 120 and access the memory 110 to display image frames in a reverse display order.

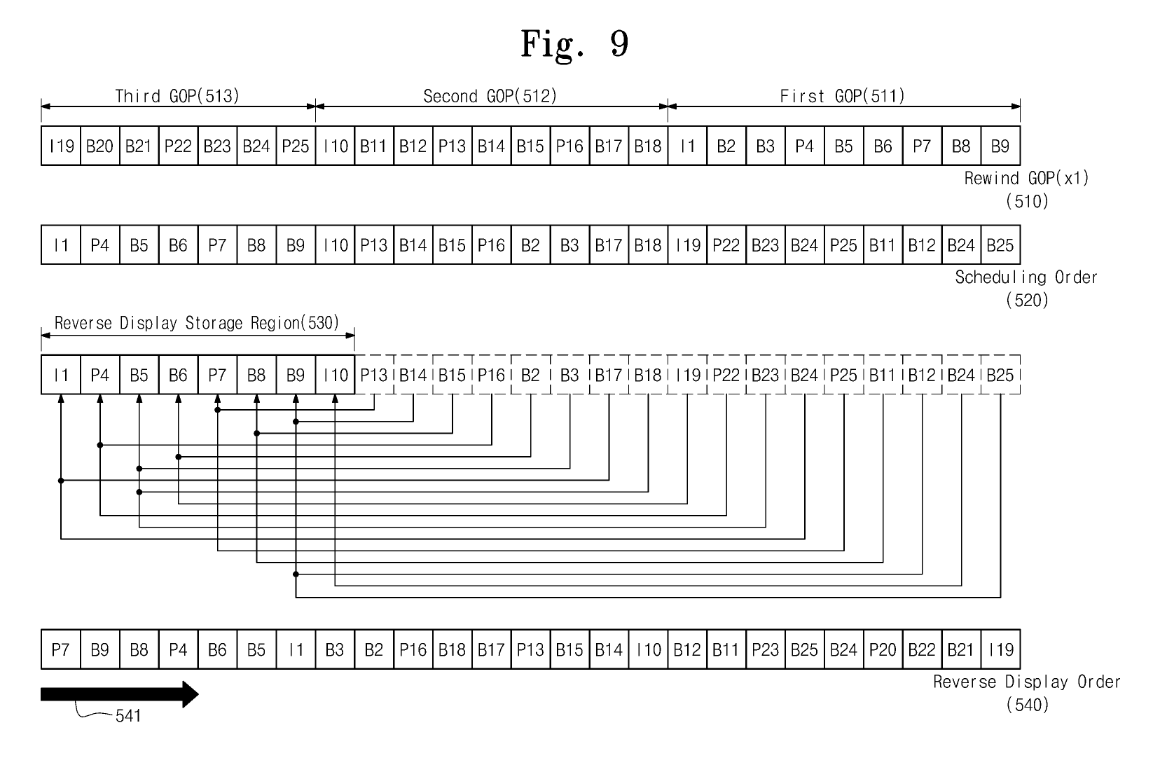

FIG. 9 illustrates an image scheduling operation when a reference image is not included in one image area, according to another exemplary embodiment.

Reverse display GOPs 510 are GOPs for single-speed (1×) reverse display and include a first GOP 511, a second GOP 512, and a third GOP 513.

The first GOP 511 is displayed ahead of the second GOP 512. Also, the second GOP 512 is displayed ahead of the third GOP 513. The first GOP 511 and the second GOP 513 each include nine image frames, and the third GOP 513 includes seven image frames.

The first GOP 511 includes image frames I1, B2, B3, P4, B5, B6, P7, P8, and B9, wherein the letters I, B and P represent kinds of image frames (I-frame, P-frame, and B-frame) and the numerals represent indexes of the image frames. The second GOP 512 includes I10, B11, B12, P13, B14, B15, P16, B17, and B18. The third GOP 513 includes 119, P20, B21, B22, P23, B24, and B25.

A stream scheduler 110 receives an image stream including the first GOP 511, the second GOP 512, and the third GOP 513. The stream scheduler 110 performs a scheduling operation which is similar to that in FIG. 7 or FIG. 8.

The stream scheduler 110 schedules another GOP after scheduling image frames except an image frame referring to the GOP. Even in another GOP, the stream scheduler 110 schedules images except an image frame referring to further another GOP. The stream scheduler 110 schedules image frames except a previous GOP after scheduling the next GOP.

The scheduling order 520 of the image frames scheduled by the stream scheduler 110 is as follows: I1→P4→B5→B6→P7→B8→B9→I10→P13→B14→B15→P16→B2→B3→B17→B18→I19→P20→B21→B22→P23→B11→B12→B24→B25→P18→B19→B20.

A decoder 120 decodes the image frames in the same order as scheduled by the stream scheduler 110. The image frames decoded by the decoder 120 are stored in a reverse display storage region 530 in a memory 130. The reverse display storage region 530 is shown by a solid line. The reverse display storage region 530 has capacity to store the smaller number of image frames (seven image frames) than one GOP (nine image frames). Therefore, the reverse display storage region 530 may store maximum seven image frames.

The decoder 120 sequentially stores the image frames I1, P4, B5, B6, P7, B8, B9, and 110 in the reverse display storage region 530 of the memory 130. The decoder 120 sequentially stores the image frames P13, B14, B15, P16, B2, B3, B17, B18, 119, P20, B21, B22, P23, B11, B12, B24, B25, P18, B19, and B20 in storage regions of display-terminated image frames in the reverse display storage region 530.

For example, a display unit 140 may display the image frame P7 that is a first reverse display image frame when the image frame 110 is stored in the memory 130. Therefore, the decoder 120 stores the image frame P13 in a storage region of the display-terminated image frame P7. In an image frame reverse display order 540, the decoder 120 stores the image frames B14, B15, P16, B2, B3, B17, B18, 119, P20, B21, B22, P23, B11, B12, B24, and B25 in storage regions of the image frames B9, B8, P4, B6, B5, I1, B3(B5), B2(B6), P16(P4), B18(B5), B17(I1), P13(P7), B15(B8), B14(B9), I10, and B12(B9), respectively.

Image frames are reversely displayed in a reverse display order 540. At this point, the reverse display order 540 of the image frames is as follows: P7→B9→B8→P4→B6→B5→I1→B3→B2→P16→B18→B17→P13→B15→B14→I10→B12→B11→P23→B25→B24→P20→B22→B21→I19. A display unit 140 reversely displays image frames in a reverse display order 240. A reverse display direction based on the reverse display order 240 is shown by arrows 541. The display unit 140 may confirm storage region information of each image frame through the decoder 120 and access the memory 110 to display image frames in a reverse display order.

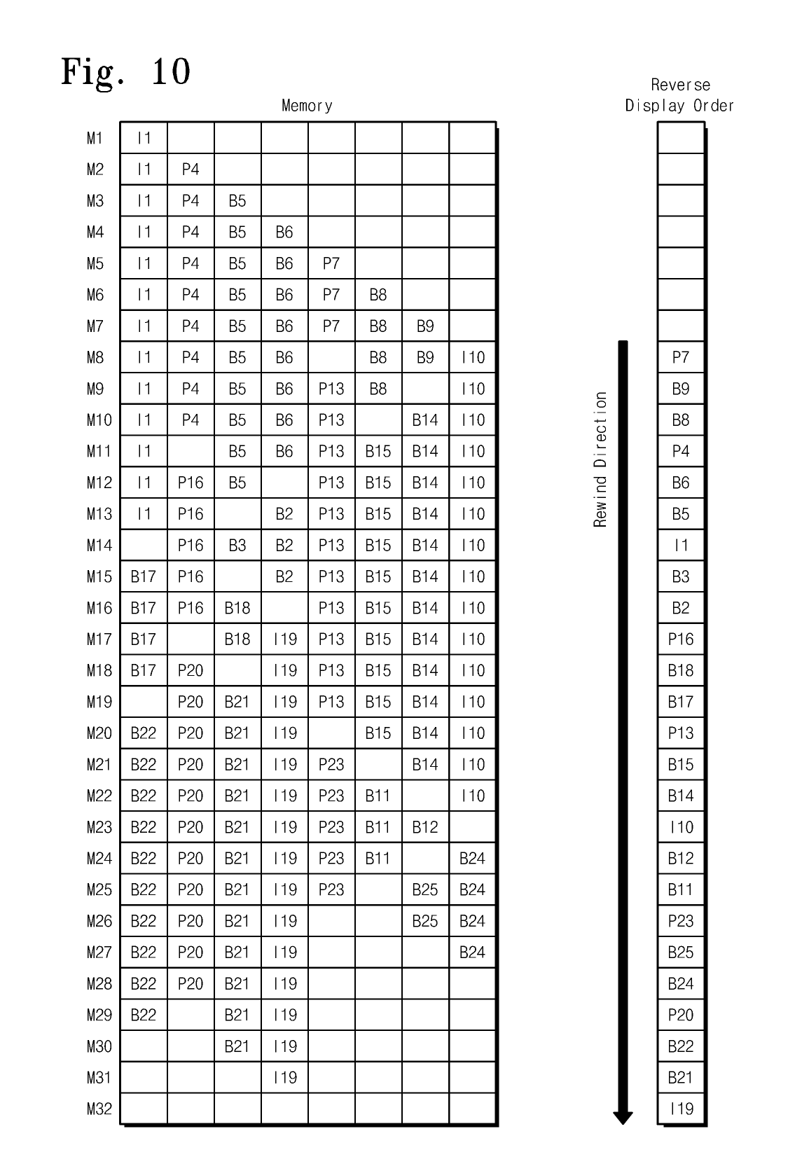

FIG. 10 illustrates image storage and display operations when a reference image is not included in one image area, according to another exemplary embodiment.

Referring to FIG. 10, image frames stored in a reverse display storage region 530 in a memory 130 vary with operations of a decoder 120 and a display unit 140. The reverse display storage region 530 corresponds to the reverse display storage region 530 described in FIG. 9.

A row direction of the memory 130 is the reverse display storage region 530 and is capable of storing eight image frames. A column direction of the memory 130 is a reverse display storage region 530 storing decoded image frames therein. In FIG. 10, M1 to M32 represent row indexes indicating reverse display storage regions 530 depending on time order, respectively.

On the row indexes M1 to M8, image frames I1, P4, B5, B6, P7, B8, B9, and 110 decoded in their scheduled order are sequentially stored in the reverse display storage region 530 in the memory 130. At this point, on the row index M8, a display unit 140 displays the image frame P7 when the image frame 110 is stored in the reverse display storage region 530 by the decoder 120.

On the row index M9, the display unit 140 displays the image frame B9 when the image frame P13 is stored in the reverse display storage region 530.

On the row indexes M10 to M25, the display unit 140 sequentially displays the image frames ‘B8, P4, B6, B5, I1, B3, B2, P16, B18, B17, P13, B15, B14, I10, B12, and B11 when the image frames P13, B14, B15, P16, B2, B3, B17, B18, 119, P20, B21, B22, P23, B11, B12, B24, and B25 are sequentially stored in the reverse display storage region 530.

On the row indexes M26 to M32, the display unit 140 displays the image frames P23, B25, B24, P20, B22, B21, and 119. On the row indexes M26 to M32, additional image frames are not stored in the reverse display storage region 530 because the decoder 130 stores all the image frames for reverse display.

As shown in FIGS. 9 and 10, GOPs of different sizes may be reversely displayed. At this point, the reverse display storage region 530 may employ a GOP capable of storing eight image frames that is smaller than one GOP capable of storing nine image frames.

It is assumed that a size of a GOP is G, the number of non-reference images between a first reference image and a second reference image in the GOP is R, and the number of non-reference images following the last reference image in the GOP is N. When R is smaller than N, a size of a reverse display storage region may be set to “G-R+1”. On the other hand, when R is larger than N, the size of the reverse display storage region may be set to “G-N+1”.

A size of a reverse display storage region proposed by the inventive concept may be set to a size of a region capable of storing one GOP and one image frame therein. However, as shown in FIGS. 9 and 10, the reverse display storage region may be set to a smaller size of a region capable of storing image frames of one GOP and one image frame therein. Accordingly, the reverse display storage region may be set within a memory in order not to exceed a size of a region capable of storing one GOP and one image frame therein.

An image display apparatus proposed by the inventive concept may be applied to apparatuses capable of displaying images such as televisions (TVs), digital versatile disk (DVD) players, portable media players, mobile phones or the like.

According to the exemplary embodiments described above, an image display apparatus uses only a predetermined size of storage region in which image frames are stored for reverse display to minimize a size of a memory for use in 1× reverse display.

While exemplary embodiments have been particularly shown and described, it will be apparent to those of ordinary skill in the art that various changes in form and detail may be made therein without departing from the spirit and scope of the inventive concept as defined by the following claims.

What is claimed is:

1. An image display apparatus comprising:
a stream scheduler configured to schedule image frames in an image stream;
a memory including a reverse display storage region allocated for reverse display;
a decoder configured to decode the scheduled image frames and store the decoded image frames in the reverse display storage region of the memory; and
a display unit configured to reversely display the decoded image frames stored in the reverse display storage region by the decoder,
wherein the decoder stores subsequent decoded image frames following the decoded image frames in storage regions of reverse-display-terminated image frames in the reverse display store region if the decoded image frames are all stored in the reverse display storage region.

2. The image display apparatus as set forth in claim 1, wherein:
if the decoded image frames are all stored in the reverse display storage region, the display unit reversely displays the image frames stored in the reverse display storage region in a predetermined reverse display order.

3. The image display apparatus as set forth in claim 1, wherein:
if a group of pictures (GOP) comprising the image frames stored in the reverse display storage region is a last GOP, the display unit reversely displays the image frames stored in the reverse display storage region in a predetermined reverse display order.

4. The image display apparatus as set forth in claim 1, wherein:
the reverse display storage region has a size smaller than a size needed to store one group of pictures (GOP) and one image frame therein.

5. The image display apparatus as set forth in claim 1, wherein:
if a reference image frame of non-reference image frames in the image stream is included in a group of pictures (GOP) including the non-reference image frames, the stream scheduler schedules image frames to be decoded in a unit of one GOP.

6. The image display apparatus as set forth in claim 1, wherein:
if a reference image frame of non-reference image frames in the image stream is included in a group of pictures (GOP) that is different from a GOP including the non-reference image frames, the stream scheduler schedules other image frames except image frames referring to the different GOP to be decoded and schedules the reference image frame of the different GOP to be decoded ahead of the image frames referring to the different GOP.

7. A method for reversely displaying images of an image display apparatus, the method comprising:
scheduling image frames of an image stream;
decoding the scheduled image frames;
storing the decoded image frames in a reverse display storage region in a memory; and
reversely displaying the image frames stored in the reverse display storage region,
wherein the storing of the decoded image frames comprises, if the decoded image frames are all stored in the reverse display storage region, storing subsequent decoded image frames following the decoded image frames in storage regions of reverse-display-terminated image frames in the reverse display storage regions.

8. The method as set forth in claim 7, wherein:
the reversely displaying of the decoded image frames comprises, if the decoded image frames are all stored in the reverse display storage region, reversely displaying the image frames stored in the reverse display storage region in a predetermined reverse display order.

9. The method as set forth in claim 7, wherein:
the reversely displaying of the decoded image frames comprises, if a group of pictures (GOP) comprising image frames stored in the reverse display storage region is a last GOP for reverse display, reversely displaying the image frames stored in the reverse display storage region in a predetermined reverse display order.

10. The method as set forth in claim 7, wherein:
the reverse display storage region has a size smaller than a size needed store one group of pictures (GOP) and one image frame.

11. The method as set forth in claim 7, wherein:
the scheduling of the image frames of the image stream comprises, if a reference image frame of non-reference image frames in the image stream is included in a group of pictures (GOP) including the non-reference image frames, scheduling the image frames to be decoded in a unit of one GOP.

12. The method as set forth in claim 7, wherein:
the scheduling of the image frames of the image stream comprises:
if a reference image frame of non-reference image frames in the image stream is included in a group of pictures (GOP) including the non-reference image frames, scheduling other image frames to be decoded except image frames referring to a GOP that is different from the GOP including the non-reference image frames;
scheduling a reference image frame of the different GOP to be decoded; and
scheduling the image frames referring to the different GOP to be decoded.

13. A method for reversely displaying images of an image display apparatus, the method comprising:
scheduling image frames of an image stream in a scheduling order;
decoding the image frames in scheduling order;
storing sequentially the decoded image frames only in a reverse display storage region in a memory; and
reversely displaying the image frames stored in the reverse display storage region,
wherein a size of the reverse display storage region is less than equal to a size needed to store one group of pictures (GOP) and one image frame.

14. The method as set forth in claim 13, wherein the storing of the decoded image frames comprises, after the reverse display storage region is filled with decoded image frames, storing decoded image frames following the stored decoded image frames in regions of the reverse display storage region in which reverse displaying of the stored decoded image frames is terminated.

15. The method as set forth in claim 13, wherein the reversely displaying of the decoded image frames comprises, if a GOP comprising image frames stored in the reverse display storage region is a last GOP for reverse display, reversely displaying the image frames stored in the reverse display storage region in a predetermined reverse display order.

16. The method as set forth in claim 13, wherein the scheduling of the image frames of the image stream comprises, if a reference image frame of non-reference image frames in the image stream is included in a group of pictures (GOP) including the non-reference image frames, scheduling the image frames to be decoded in a unit of one GOP

17. The method as set forth in claim 13, wherein the scheduling of the image frames of the image stream comprises:
if a reference image frame of non-reference image frames in the image stream is included in a GOP including the non-reference image frames, scheduling other image frames to be decoded except image frames referring to a GOP that is different from the GOP including the non-reference image frames;
scheduling a reference image frame of the different GOP to be decoded; and
scheduling the image frames referring to the different GOP.

18. The method as set forth in claim 13, wherein the size of the reverse display storage region is less than the size needed to store one GOP and one image frame.
